(19) United States
(12) Patent Application Publication
(10) Pub. No.: US 2025/0270119 A1
(43) Pub. Date: Aug. 28, 2025

(54) LIQUID TREATMENT DEVICE AND SEPARATION MEMBRANE

(71) Applicant: SEIKO EPSON CORPORATION, Tokyo (JP)

(72) Inventor: Masaaki ANDO, MATSUMOTO-SHI (JP)

(21) Appl. No.: 19/063,975

(22) Filed: Feb. 26, 2025

(30) Foreign Application Priority Data
Feb. 26, 2024 (JP) 2024-026132

(51) Int. Cl. C02F 1/44; B01D 61/36; B01D 69/02; B01D 69/04; C02F 101/30

(52) U.S. Cl. CPC C02F 1/447; B01D 61/364; B01D 69/02; B01D 69/04; B01D 2325/38; C02F 2101/308; C02F 2301/046

(57) ABSTRACT

A liquid treatment device includes a liquid storage unit that stores water to be treated in which a water-soluble substance is dissolved, a heating unit that heats the water to be treated in the liquid storage unit, and a distillation unit that separates, using a membrane distillation method, the water-soluble substance and a moisture content from the water to be treated. The distillation unit includes a liquid-phase portion into which the water to be treated flows from the liquid storage unit, a separation portion that is a non-woven fabric using a recycled material as a raw material and on which a carbonization treatment has been performed, and a gas-phase portion in which water vapor, which is generated as a result of the water to be treated passing through the separation portion, diffuses.

The present application is based on, and claims priority from JP Application Serial Number 2024-026132, filed Feb. 26, 2024, the disclosure of which is hereby incorporated by reference herein in its entirety.

### BACKGROUND

### 1. Technical Field

The present disclosure relates to a liquid treatment device and a separation membrane.

### 2. Related Art

In related art, a liquid treatment device is known that separates a moisture content from water to be treated containing a water-soluble substance (for example, see JP-A-2003-155656). JP-A-2003-155656 discloses a dyeing and finishing system for fibers in which a reverse osmosis membrane is used to separate dyeing waste water and to concentrate a used chemical agent.

When a separation portion that requires a periodic replacement, such as a reverse osmosis membrane in a reverse osmosis membrane method, is used, depending on the manufacturing cost of the separation portion, there is a risk that the maintenance cost may increase. In addition, depending on the type of the separation portion, there is a risk that a load on the environment may increase.

### SUMMARY

An aspect of the present disclosure is a liquid treatment device that includes a liquid storage unit configured to store water to be treated in which a water-soluble substance is dissolved, a heating unit configured to heat the water to be treated in the liquid storage unit, and a distillation unit configured to separate, using a membrane distillation method, the water-soluble substance and a moisture content from the water to be treated. The distillation unit includes a liquid-phase portion into which the water to be treated flows from the liquid storage unit, a separation portion that is a non-woven fabric using a recycled material as a raw material and on which a carbonization treatment has been performed, and a gas-phase portion into which water vapor diffuses, the water vapor being generated as a result of the water to be treated passing through the separation portion.

Another aspect of the present disclosure is a separation portion configured to be used for membrane distillation that separates a water-soluble substance and a moisture content from water to be treated. The separation portion is a non-woven fabric using a recycled material as a raw material and having hydrophobicity imparted by a carbonization treatment.

### BRIEF DESCRIPTION OF THE DRAWINGS

FIG. 1 is a schematic diagram of a first liquid treatment device according to a first embodiment.

FIG. 2 is a schematic diagram of a second liquid treatment device according to a first modified example.

FIG. 3 is a schematic diagram of a third liquid treatment device according to a second modified example.

FIG. 4 is a diagram illustrating an example of a configuration of a separation module.

FIG. 5 is a configuration diagram of a sheet manufacturing apparatus.

FIG. 6 is a flowchart illustrating a manufacturing process of a fiber structure.

### DESCRIPTION OF EMBODIMENTS

### 1. First Embodiment

### 1-1. Configuration of Liquid Treatment Device

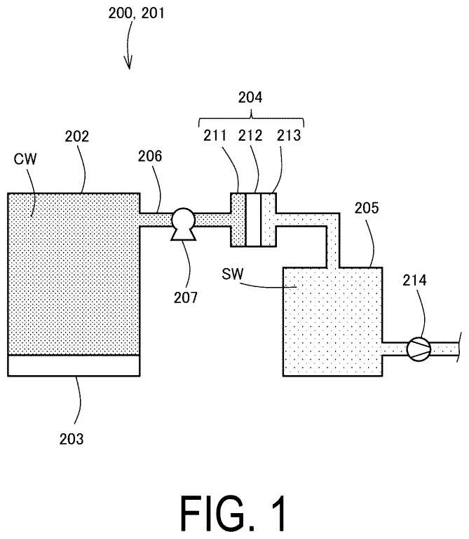

FIG. 1 is a schematic diagram of a first liquid treatment device according to a first embodiment. A first liquid treatment device 201 corresponds to an example of a liquid treatment device.

The first liquid treatment device 201 includes a liquid storage unit 202, a heating unit 203, a distillation unit 204, and a first recovery unit 205. The first liquid treatment device 201 separates a moisture content from water to be treated using a membrane distillation method.

The liquid storage unit 202 stores water to be treated CW that is a liquid in which a water-soluble substance is dissolved. The liquid storage unit 202 may be constituted as a water storage tank, or may be constituted as a pipe through which the water to be treated flows. The water to be treated CW is illustrated with a dot pattern for the purpose of description.

In the water to be treated CW, ink is dissolved as the water-soluble substance.

The liquid storage unit 202 is heated by the heating unit 203. The water to be treated CW stored in the liquid storage unit 202 is heated by the heating unit 203. Note that the heating of the water to be treated CW by the heating unit 203 is performed to such an extent that the water to be treated CW does not boil.

For example, the heating unit 203 heats the water to be treated CW to 60° C. The heating unit 203 may be provided inside or outside the liquid storage unit 202. The temperature of the water to be treated CW heated by the heating unit 203 may be a temperature suitable for the membrane distillation method, and may be higher or lower than 60° C.

A water pipe 206 is attached to the liquid storage unit 202. The water pipe 206 includes a pump 207. The pump 207 circulates the water to be treated CW between the liquid storage portion 202 and the distillation unit 204.

The distillation unit 204 is coupled to the water pipe 206.

The distillation unit 204 includes a liquid-phase portion 211 coupled to the water pipe 206, a separation portion 212 in contact with the liquid-phase portion 211, and a gas-phase portion 213 disposed at a position opposite to the liquid-phase portion 211 with respect to the separation portion 212. The separation portion 212 is a separation membrane that serves as a membrane member constituted by a fiber structure to be described later. The separation portion 212 corresponds to an example of a separation membrane.

The water to be treated CW pumped up by the pump 207 is received in the liquid-phase portion 211, is changed into a gaseous state while passing through the separation portion 212, and diffuses into the gas-phase portion 213.

A gas SW that has diffused to the gas-phase portion 213 side is water contained in the water to be treated, and is treated water treated by the separation portion 212. That is, the gas SW is treated water in a gaseous state. The gas SW is illustrated with a dot pattern for the purpose of description.

The gas-phase portion 213 is coupled to the first recovery unit 205. A depressurizing unit 214 is coupled to the first recovery unit 205. By the depressurizing unit 214 depressurizing air containing the gas SW inside the gas-phase portion 213 and the first recovery portion 205, the gas SW having passed through the gas-phase portion 213 is recovered from the first recovery unit 205.

The depressurizing unit 214 may be constituted by, for example, a Peltier element that reduces the pressure by cooling the air in the gas-phase portion 213. The depressurizing unit 214 may also be constituted by a suction pump.

By condensing the gas SW using the depressurizing unit 214, treated water in a liquid state is obtained. Such a membrane distillation method is called vacuum membrane distillation (VMD).

### 1-2. First Modified Example

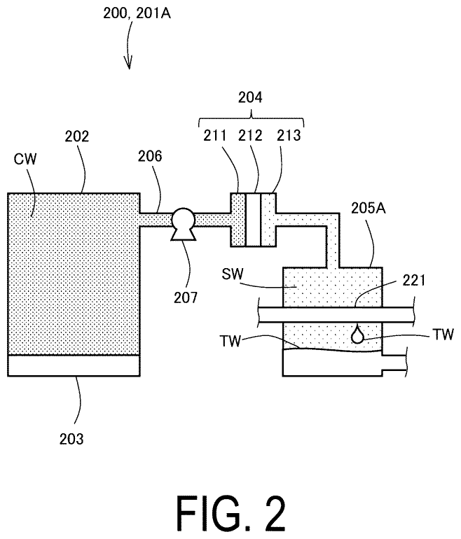

FIG. 2 is a schematic diagram of a second liquid treatment device 201A according to a first modified example. The same configuration as in FIG. 1 will be denoted by the same reference sign, and a detailed description thereof will be omitted. The second liquid treatment device 201A corresponds to an example of the liquid treatment device.

A cooling pipe 221, through which cooling water flows, is coupled to a second recovery unit 205A. The cooling pipe 221 is provided so as to penetrate the inside of the second recovery unit 205A. Since the cooling water flows through the cooling pipe 221, the gas SW flowing in from the distillation unit 204 is condensed at the outer surface of the cooling pipe 221. As a result, treated water TW in a liquid state is obtained. By recovering the treated water TW in the liquid state from the second recovery unit 205A, treated water is obtained. Such a membrane distillation method is called air gap membrane distillation (AGMD).

Note that the cooling pipe 221 is an example, and any cooling unit capable of condensing the gas SW diffused from the distillation unit 204 may be adopted. For example, a fin through which cooling water flows may be used as the cooling unit.

### 1-3. Second Modified Example

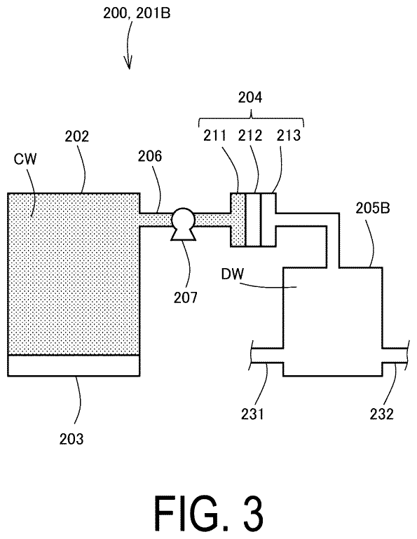

FIG. 3 is a schematic diagram of a third liquid treatment device 201B according to a second modified example. The third liquid treatment device 201B corresponds to an example of the liquid treatment device.

A third recovery unit 205B is filled with cooling water DW having a temperature lower than that of the water to be treated CW that has been heated. In this case, the gas-phase portion 213 is filled with the cooling water DW. The cooling water DW is water that has been treated to a quality equal to or higher than that of treated water, and is water that does not contain ink. Examples of the cooling water DW include tap water and pure water.

An upstream pipe 231 and a downstream pipe 232 are coupled to the third recovery unit 205B, and the cooling water DW flows through the third recovery unit 205B. The cooling water DW flows in from the upstream pipe 231 and flows out from the downstream pipe 232.

The gas diffused from the distillation unit 204 is condensed by being cooled by the cooling water DW filled in the third recovery unit 205B and the gas-phase portion 213. Accordingly, the gas diffused from the distillation unit 204 is mixed with the cooling water DW. By recovering the mixed liquid, discharged from the downstream pipe 232, that is composed of treated water and the cooling water DW, treated water is obtained. Such a membrane distillation method is called direct contact membrane distillation (DCMD).

In the third liquid treatment device 201B illustrated in FIG. 3, a configuration is adopted in which the cooling water DW flows through the third recovery unit 205B, but the cooling water DW may be replaced with a sweeping gas. The sweeping gas is preferably a gas which is inert to water, such as dry air or nitrogen, for example. Such a membrane distillation method is called sweeping gas membrane distillation (SGMD).

When the first liquid treatment device 201, the second liquid treatment device 201A, and the third liquid treatment device 201B are not particularly distinguished from one another, they are referred to as a liquid treatment device 200.

### 1-4. Modified Example of Separation Unit

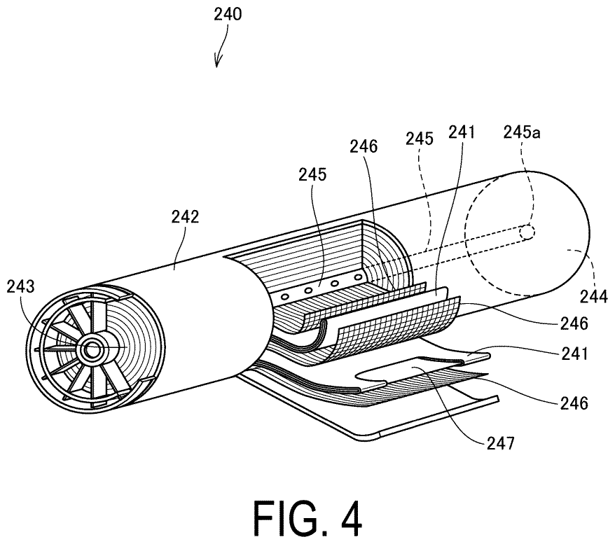

FIG. 4 is a diagram illustrating an example of a configuration of a separation module 240.

The separation portion 240 may be used as the separation portion 212 described above with reference to FIGS. 1, 2, and 3. The separation module 240 is a modified example of the separation portion 212.

The separation module 240 includes a housing unit 242 formed in a cylindrical shape.

The housing unit 242 includes an inflow port 243 into which the water to be treated flows from the liquid-phase portion 211, and an outflow port 244 that is provided at a surface facing the inflow port 243 and returns the water to be treated to the liquid-phase portion 211. The housing unit 242 includes a central pipe 245 that discharges the treated water.

A plurality of separation membranes 241, which are wound in a circumferential manner, are housed in the housing unit 242. The separation membrane 241 is formed of a fiber structure to be described later. The plurality of separation membranes 241 stored in the housing unit 242 are coaxially stacked in a state of being wound in a cylindrical shape. Alternatively, a configuration may be adopted in which the separation membrane 241, which is longer than the outer circumference of the housing unit 242, is wound in a roll shape and housed in the housing unit 242. In this case, the separation membrane 241 may be one sheet.

The separation membranes 241 are provided so as to cover a water channel member 247. End portions of the separation membranes 241 and the water channel member 247 are joined to the central pipe 245. A spacer 246 is provided between the separation membranes 241 adjacent to each other. The spacer 246 is formed in a mesh shape.

The water to be treated, which has been received from the inflow port 243, flows along the spacer 246 and passes through the separation membranes 241 to become the treated water. Then, the treated water flows to the central pipe 245 along the water channel member 247. An outlet 245a of the central pipe 245 is coupled to the gas-phase portion 213.

The water to be treated in which ink has been concentrated by the separation membranes 241 is returned from the inflow port 243 to the liquid-phase portion 211 or the liquid storage portion 202 through a pipe (not illustrated) coupled to the liquid-phase portion 211.

A plurality of the separation modules 240 as described above may be arranged in parallel to constitute the separation portion 212. Alternatively, a plurality of the separation modules may be arranged both in parallel and in series to constitute the separation portion 212.

### 1-5. Sheet Manufacturing Apparatus

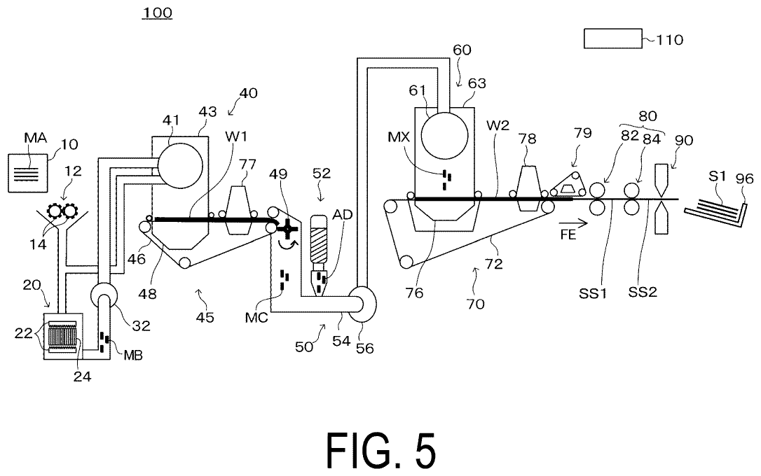

FIG. 5 is a diagram illustrating a configuration of a sheet manufacturing apparatus 100. The sheet manufacturing apparatus 100 manufactures a sheet S1 which is a material of a fiber structure to which the present disclosure is applied. The sheet S1 and the fiber structure are non-woven fabrics.

The sheet manufacturing apparatus 100 includes a supply unit 10, a crushing unit 12, a defibration unit 20, a sorting unit 40, a first web forming unit 45, a rotating body 49, a mixing unit 50, a dispersing unit 60, a second web forming unit 70, a web transport unit 79, a processing unit 80, and a cutting unit 90.

The sheet manufacturing apparatus 100 produces the sheet S1 by fiberizing a raw material MA that contains fibers described later such as a wood-based pulp material, kraft pulp, waste paper, synthetic pulp, or fabric offcuts.

The raw material MA may be any material containing cellulose fibers. For example, a wood-based pulp material, kraft pulp, waste paper, synthetic pulp, or fabric offcuts can be used. Examples of the wood-based pulp material include mechanical pulp produced by a mechanical treatment such as ground pulp, chemical pulp produced by a chemical treatment, and semichemical pulp and chemiground pulp produced by a combination of the mechanical and chemical treatments. The pulp may be either bleached pulp or unbleached pulp. Examples of the pulp include virgin pulp, such as softwood bleached kraft pulp (N-BKP) and hardwood bleached kraft pulp (L-BKP), and bleached chemi-thermomechanical pulp (BCTMP). Nanocellulose fibers (NCF) may also be used. The waste paper is used paper such as plain paper copy (PPC) paper after printing, a magazine, and a newspaper. Examples of the synthetic pulp include SWP manufactured by Mitsui Chemicals, Inc. SWP is a registered trademark.

The raw material MA may contain carbon fibers, metal fibers, or thixotropic fibers in addition to or instead of the above-described wood-based pulp material, waste paper, synthetic pulp, or the like. Thus, the raw material MA may be a mixture obtained by mixing a plurality of materials selected from the above-described wood-based pulp material, waste paper, synthetic pulp, carbon fibers, metal fibers, and thixotropic fibers.

Examples of the fabric offcuts include cotton offcuts generated in a textile factory, and used clothes. The raw material MA may further contain natural fibers derived from nature in addition to the fabric offcuts. Examples of the natural fibers include fibers made of cellulose, silk, wool, cotton, hemp, kenaf, flax, ramie, jute, manila, sisal, conifer, and hardwood. These natural fibers are examples of a natural material.

The raw material MA may further contain synthetic fibers. Examples of the synthetic fibers include fibers made of rayon, lyocell, cupra, vinylon, acrylic, nylon, aramid, polyester, polyethylene, polypropylene, polyurethane, and polyimide. In particular, among these synthetic fibers, a synthetic fiber using a natural material is preferable from the viewpoint of suppressing the environmental load. The synthetic fiber using the natural material corresponds to an example of a regenerated fiber. These various fibers may be used independently, may be appropriately mixed and used, or may be refined and used. Note that, in particular, as the raw material MA of the fiber structure used for forming the separation membrane in the membrane distillation method, hydrophobic fibers are preferable.

The raw material MA, and a defibrated material MB and a fiber material MC, both of which will be described later, can be referred to as materials containing fibers. The raw material MA corresponds to an example of a recycled material.

The supply unit 10 supplies the raw material MA to the crushing unit 12. The crushing unit 12 is a shredder that shreds the raw material MA using a crushing blade 14. The raw material MA cut by the crushing unit 12 is transported to the defibration unit 20 through a pipe.

The defibration unit 20 defibrates shreds cut by the crushing unit 12 using a dry method to produce the defibrated material MB. Defibration is a process of untangling the raw material MA, in which a plurality of fibers are bound to each other, into one fiber strand or a small number of fiber strands. The dry method refers to a method in which a treatment such as defibration is performed not in a liquid but in a gas such as air. The defibrated material MB contains the fibers that were contained in the raw material MA. The defibrated material MB may also contain a substance other than the fibers that were contained in the raw material MA. For example, when the waste paper is used as the raw material MA, the defibrated material MB contains components such as resin particles, colorants such as ink or toner, anti-bleeding agents, and paper strengthening agents.

The defibration unit 20 is, for example, a mill that includes a stator 22 having a cylindrical shape and a rotor 24 that rotates inside the stator 22, and defibrates the shreds by sandwiching the shreds between the stator 22 and the rotor 24. The defibrated material MB is sent to the sorting unit 40 through a pipe.

The fiber length of the fibers contained in the raw material MA or of the fibers contained in the defibrated material MB is from 0.1 mm to 100 mm, and is preferably from 0.5 mm to 50 mm. Further, the fiber diameter of these fibers is from 0.1 μm to 1000 μm, and is preferably from 1 μm to 500 μm. These fibers may include a plurality of types of fibers, or may include fibers having different fiber lengths and/or fiber diameters. The fiber length and the fiber width can be determined by, for example, performing measurements using a fiber tester (manufactured by Lorentzen & Wettre) and calculating length-weighted average values.

The sorting unit 40 includes a drum unit 41 and a housing unit 43 housing the drum unit 41. The drum unit 41 is a sieve having openings such as a net, a filter, and a screen, and is rotated by power generated by a motor (not illustrated). The defibrated material MB is untangled inside the rotating drum unit 41, and falls after passing through the openings of the drum unit 41. Of the components of the defibrated material MB, components that do not pass through the openings of the drum unit 41 are transported to the defibration unit 20 through a pipe.

The first web forming unit 45 includes an endless mesh belt 46 having a large number of openings. The first web forming unit 45 produces a first web W1 by depositing, on the mesh belt 46, fibers and the like falling from the drum unit 41. Of the components falling from the drum unit 41, components smaller than the openings of the mesh belt 46 pass through the mesh belt 46 and are sucked and removed by a suction unit 48. Accordingly, short fibers, plastic particles, ink, toner, anti-bleeding agents, and the like, which are not suitable for manufacturing the sheet S1, are removed from the components of the defibrated material MB.

A humidifier 77 is disposed on a movement path of the mesh belt 46, and the first web W1 deposited on the mesh belt 46 is humidified with mist-like water or high-humidity air.

The first web W1 is transported by the mesh belt 46 and comes into contact with the rotating body 49. The rotating body 49 divides the first web W1 by a plurality of blades to produce the fiber material MC. The fiber material MC is transported to the mixing unit 50 through a pipe 54.

The mixing unit 50 includes an additive supply unit 52 that adds an additive material AD to the fiber material MC, and a mixing blower 56 that mixes the fiber material MC and the additive material AD. The additive material AD will be described later.

The mixing blower 56 generates an air flow in the pipe 54 through which the fiber material MC and the additive material AD are transported, mixes the fiber material MC and the additive material AD, and transports a mixture MX to the dispersing unit 60.

The dispersion unit 60 includes a drum unit 61 and a housing unit 63 housing the drum unit 61. The drum unit 61 is a cylindrical sieve configured similarly to the drum unit 41, and is driven to rotate by a motor (not illustrated). Due to the rotation of the drum unit 61, the mixture MX is untangled and falls inside the housing unit 63.

The second web forming unit 70 includes an endless mesh belt 72 having a large number of openings. The second web forming unit 70 deposits, on the mesh belt 72, the mixture MX falling from the drum unit 61 to produce a second web W2. Of the components of the mixture MX, components smaller than the openings of the mesh belt 72 pass through the mesh belt 72, and are sucked by a suction unit 76.

A humidifier 78 is disposed on a movement path of the mesh belt 72, and the second web W2 deposited on the mesh belt 72 is humidified with mist-like water or high-humidity air.

The second web W2 is peeled off from the mesh belt 72 by the web transport unit 79 and transported to the processing unit 80. The processing unit 80 includes a pressurizing unit 82 and a heating unit 84. The pressurizing unit 82 nips the second web W2 between a pair of pressurizing rollers and pressurizes the second web W2 at a predetermined nip pressure to form a pressurized sheet SS1. The heating unit 84 applies heat to the pressurized sheet SS1 while nipping the pressurized sheet SS1 between a pair of heating rollers. Accordingly, fibers contained in the pressurized sheet SS1 are bound by a resin contained in the additive material AD to form a heated sheet SS2. The heated sheet SS2 is transported to the cutting unit 90.

The cutting unit 90 cuts the heated sheet SS2 in a direction intersecting a transport direction FE and/or in a direction along the transport direction FE to produce the sheet S1 having a predetermined size. The sheet S1 is stored in the discharge unit 96.

The sheet manufacturing apparatus 100 includes a control device 110. The control device 110 controls each unit of the sheet manufacturing apparatus 100 including the defibration unit 20, the additive supply unit 52, the mixing blower 56, the dispersing unit 60, the second web forming unit 70, the processing unit 80, and the cutting unit 90 to perform a method of manufacturing the sheet S1. Further, the control device 110 may control operations of the supply unit 10, the sorting unit 40, the first web forming unit 45, and the rotating body 49.

The additive material AD bonds a plurality of fibers to each other by cross-linking the fibers to form the fibers into a sheet shape. The additive material AD contains a resin that functions as a bonding material for binding fibers to each other. Specifically, the additive material AD contains a thermoplastic resin and/or a thermosetting resin. The additive material AD may contain a thermoplastic core-sheath resin. In addition to the resin, the additive material AD may also contain a coloring agent, an aggregation inhibitor, a flame retardant, or the like.

As the thermoplastic resin, for example, a resin having a melting temperature of 60° C. or higher and 200° C. or lower and a deformation temperature of 50° C. or higher and 180° C. or lower can be used. The additive material AD contains one or a plurality of the resins described above. For example, the additive material AD may contain a plurality of resins having different glass transition temperatures Tg or melting points.

Further, the resin contained in the additive material AD is preferably in the form of particles or fibers.

In addition to the above-described resin, the additive material AD may contain an inorganic filler material, rigid fibers, or thixotropic fibers as a reinforcing material that increases the rigidity of a crosslinked structure in which fibers are bound to each other. As the inorganic filler material, for example, calcium carbonate, mica or the like can be used. As the rigid fibers, for example, carbon fibers, glass fibers, and metal fibers can be used. Further, high-rigidity fibers such as Kevlar or other aramid fibers can also be used. Kevlar is a registered trademark. Examples of the thixotropic fibers include cellulose nanofibers.

### 1-6. Manufacturing Process of Fiber Structure

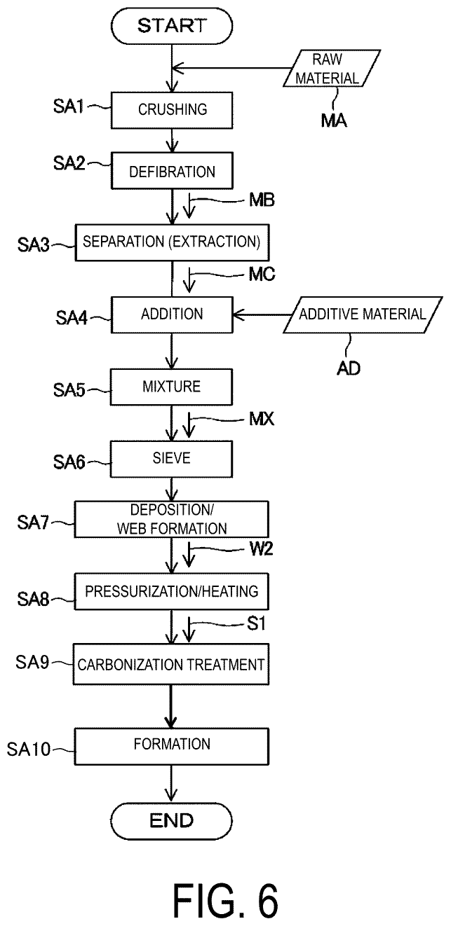

FIG. 6 is a flowchart illustrating a manufacturing process of a fiber structure to which the present disclosure is applied. The manufacturing process illustrated in FIG. 6 includes a step of manufacturing the sheet S1 by the sheet manufacturing apparatus 100.

Step SA1 is a crushing step of crushing the raw material MA, and corresponds to, for example, processing by the crushing unit 12 of the sheet manufacturing apparatus 100. The crushing step is a step of cutting the raw material MA into a predetermined size or less. The predetermined size is, for example, from 1 cm to 5 cm square. When the raw material MA is supplied in a cut state, step SA1 can be omitted.

Step SA2 is a defibration step and corresponds to, for example, processing by the defibration unit 20 of the sheet manufacturing apparatus 100.

Step SA3 is a step of extracting a material mainly composed of the fibers from the defibrated material MB, and is referred to as a separation step. The separation step is a step of separating particles such as resin and additives from the defibrated material MB that contains fibers, resin particles, and the like, and of extracting a material mainly composed of fibers. The separation step corresponds to, for example, processing involving the sorting unit 40 and the rotating body 49 of the sheet manufacturing apparatus 100.

When the raw material MA supplied at step SA1 does not contain particles or the like that affect the manufacturing of the sheet S1, or when there is no need to remove particles or the like from the components contained in the raw material MA, the separation step at step SA3 can be omitted. In this case, the defibrated material MB is directly used as the fiber material MC.

Step SA4 is an addition step and is a step of adding the additive material AD to the fiber material MC that has been separated at step SA3. The addition step corresponds to, for example, processing by the additive agent supply unit 52 of the sheet manufacturing apparatus 100.

Step SA5 is a mixing step and is a step of mixing the fiber material MC and the additive material AD to produce the mixture MX. The mixing step corresponds to, for example, processing by the mixing unit 50 of the sheet manufacturing apparatus 100.

Step SA6 is a sieving step and is a step of sieving the mixture MX, dispersing the mixture MX in the atmosphere, and then causing the mixture MX to fall. The sieving step corresponds to, for example, processing by the dispersing unit 60 of the sheet manufacturing apparatus 100.

Step SA7 is a deposition step and is a step of depositing the mixture MX that is caused to fall in the sieving step at step SA6, and forming a web. The deposition step corresponds to, for example, processing of forming the second web W2 by the second web forming unit 70 of the sheet manufacturing apparatus 100.

Step SA8 is a pressurizing and heating step in which the web is pressurized and heated. The pressurizing and heating step corresponds to, for example, processing in which the second web W2 is pressurized and heated by the processing unit 80 of the sheet manufacturing apparatus 100 to form the sheet S after forming the pressurized sheet SS1 and the heated sheet SS2. The order of pressurization and heating in the pressurizing and heating step is not limited, but the pressurization is preferably performed first.

Step SA9 is a carbonization treatment step of performing a carbonization treatment on the sheet S1. The carbonization treatment corresponds to processing in which a reaction such as dehydration or thermal decomposition is caused by heating to partially carbonize an organic substance contained in the sheet S1. Hydrophobicity of the sheet S1 is improved by the carbonization treatment. Note that a carbonization treatment unit that performs the carbonization treatment may be provided in the sheet manufacturing apparatus 100, or may be provided as a separate body from the sheet manufacturing apparatus 100.

Step SA10 is a formation step of forming a fiber structure using the sheet S1 on which the carbonization treatment has been performed. In the formation step, a fiber structure in the form of a membrane or the like is formed by performing processing such as coupling, joining, or bonding of the sheet S1. In the formation step, in order to join a plurality of the sheets S1, methods, such as bonding with an adhesive material, thermal fusion by melting a thermoplastic resin, skewering with a core material, and binding with a fastening component, can be used. Further, simple joining by using the roughness of fiber surfaces of the sheets S1 may be employed.

The manufacturing process illustrated in FIG. 6 is not limited to the case of using the sheet manufacturing apparatus 100. It is needless to say that the sheet S1 manufactured by another apparatus can also be used in the manufacturing process illustrated in FIG. 6. Further, the manufacturing process illustrated in FIG. 6 as the method of manufacturing the sheet S1 is an example, and the fiber structure to which the present disclosure is applied may be molded using the sheet S1 manufactured by another method.

The function of the fiber structure in membrane distillation will be described. As a separation portion of the membrane distillation, a material which does not pass the water to be treated in a liquid state but passes a vaporized moisture content contained in the water to be treated is preferable. Thus, hydrophobic and porous fibers are preferable as the material of the separation portion. As such a material, fluorocarbon-based fibers are often used, but there is a problem in that the fluorocarbon-based fibers have a large environmental load. On the other hand, a fiber structure produced from a raw material, which is a recycled material and contains no fluorocarbon-based fiber, and subjected to a carbonization treatment can be used as a separation membrane. In this way, the environmental load can be reduced.

### 7. Effects

As described above, the liquid treatment device 200 includes the liquid storage unit 202 that stores the water to be treated in which the water-soluble substance is dissolved, the heating unit 203 that heats the water to be treated in the liquid storage unit 202, and the distillation unit 204 that separates the water-soluble substance and the moisture content from the water to be treated using the membrane distillation method. The distillation unit 204 includes the liquid-phase portion 211 into which the water to be treated flows from the liquid storage unit 202, the separation portion 212 which is a non-woven fabric using a recycled material as the raw material MA and on which the carbonization treatment has been performed, and the gas-phase portion 213 into which the water vapor generated from the water to be treated diffuses through the separation portion 212 or the separation module 240.

According to this configuration, it is possible to provide the liquid treatment device 201 that can improve the hydrophobicity by the carbonization treatment and can suppress the maintenance cost and contribute to the protection of the environment by using the non-woven fabric using the recycled material as the raw material.

Further, the separation portion 212 is a separation membrane formed by binding, into a sheet-like shape, the defibrated material MB produced by defibrating the recycled material using an impact force.

According to this configuration, it is possible to provide the liquid treatment device 201 that can reduce the use of water and can contribute to the protection of the environment.

The depressurizing unit 214 that reduces the pressure of the air in the gas-phase portion 213 is further provided.

According to this configuration, since the gas-phase portion 213 is depressurized, the recovery efficiency of the treated water by the membrane distillation method is improved. The housing unit 242 that houses the separation membrane 241 in the circumferential manner is further provided. The housing unit 242 includes the inflow port 243 into which the water to be treated flows from the liquid-phase portion 211, and the outflow port 244 that is provided at the surface facing the inflow port 243 and returns the liquid containing the water-soluble substance to the liquid-phase portion 211.

According to this configuration, the surface area of the separation membrane 241 can be increased, and the recovery efficiency of the treated water by the membrane distillation method is improved.

The water-soluble substance is ink.

According to this configuration, the amount of waste water, which is discharged from a factory or the like discharging water to be treated containing ink, can be reduced.

The recycled material is a material containing hydrophobic synthetic fibers, or a material containing hydrophobic regenerated fibers using a natural material as a raw material. According to this configuration, by using the hydrophobic material, the hydrophobicity of the separation portion 212 can be further improved.

The separation membrane constituting the separation portion 212, or the separation membrane 241 included in the separation module 240 is a separation membrane that can be used in the membrane distillation method for separating the water-soluble substance and the moisture content from the water to be treated, and is the non-woven fabric using a/the recycled material as the raw material MA and having hydrophobicity imparted by the carbonization treatment.

According to this configuration, it is possible to provide a separation membrane that can improve the hydrophobicity by the carbonization treatment and can suppress the maintenance cost and contribute to the protection of the environment by using the non-woven fabric using the recycled material as the raw material.

### 3. Other Embodiments

The above-described embodiments are preferred embodiments of the disclosure. However, the present disclosure is not limited to those embodiments, and various modifications can be applied to the embodiments without departing from the gist of the present disclosure.

The fiber structure of the above-described embodiment may be applied as a separation portion in a method other than the membrane distillation method. For example, the fiber structure may be used as a separation membrane in a reverse osmosis membrane method. Although the separation portion 212 of the above-described embodiment is constituted by a separation membrane, the configuration is not limited thereto. Specifically, the separation portion 212 need not necessarily be formed in a membrane-like shape as long as the separation portion 212 has a thickness or a shape that can be used for a membrane distillation method.

### 4. Appendices

An overview of the present disclosure is provided below as appendices.

### Appendix 1

A liquid treatment device includes a liquid storage unit configured to store water to be treated in which a water-soluble substance is dissolved, a heating unit configured to heat the water to be treated in the liquid storage unit, and a distillation unit configured to separate, using a membrane distillation method, the water-soluble substance and a moisture content from the water to be treated. The distillation unit includes a liquid-phase portion into which the water to be treated flows from the liquid storage unit, a separation portion that is a non-woven fabric using a recycled material as a raw material and on which a carbonization treatment has been performed, and a gas-phase portion into which water vapor diffuses, the water vapor being generated as a result of the water to be treated passing through the separation portion.

According to this configuration, it is possible to provide the liquid treatment device that can improve the hydrophobicity by the carbonization treatment and can suppress the maintenance cost and contribute to the protection of the environment by using the non-woven fabric using the recycled material as the raw material.

### Appendix 2

In the liquid treatment device according to Appendix 1, the separation portion is a separation membrane produced by binding, into a sheet-like shape, a defibrated material produced by defibrating the recycled material using an impact force. According to this configuration, it is possible to provide the liquid treatment device that can reduce the use of water and can contribute to the protection of the environment.

### Appendix 3

The liquid treatment device according to Appendix 1 further includes a depressurizing unit configured to depressurize air in the gas-phase portion.

According to this configuration, since the gas-phase portion is depressurized, the recovery efficiency of the treated water by the membrane distillation method is improved.

### Appendix 4

In the liquid treatment device according to Appendix 2 or 3, the separation portion further includes a housing unit configured to house a separation membrane in a circumferential manner, and the housing unit includes an inflow port into which the water to be treated flows from the liquid-phase portion, and an outflow port provided at a surface facing the inflow port and configured to return a liquid containing the water-soluble substance to the liquid-phase portion.

According to this configuration, the surface area of the separation membrane can be increased, and the recovery efficiency of the treated water by the membrane distillation method is improved.

### Appendix 5

In the liquid treatment device according to any one of Appendices 1 to 4, the water-soluble substance is ink.

According to this configuration, it is possible to provide the liquid treatment device that can treat the water to be treated in which ink is dissolved at a low maintenance cost and can contribute to the protection of the environment.

### Appendix 6

In the liquid treatment device according to any one of Appendices 1 to 5, the recycled material is a material containing hydrophobic synthetic fibers, or a material containing hydrophobic regenerated fibers using a natural material as a raw material.

According to this configuration, by using the hydrophobic material, the hydrophobicity of the separation portion 212 can be further improved.

### Appendix 7

A separation portion is configured to be used for membrane distillation that separates a water-soluble substance and a moisture content from water to be treated. The separation portion is a non-woven fabric using a recycled material as a raw material and having hydrophobicity imparted by a carbonization treatment.

According to this configuration, it is possible to provide the separation portion that can improve the hydrophobicity by the carbonization treatment and can suppress the maintenance cost and contribute to the protection of the environment by using the non-woven fabric using the recycled material as the raw material.

What is claimed is:

1. A liquid treatment device, comprising:
a liquid storage unit configured to store water to be treated in which a water-soluble substance is dissolved;
a heating unit configured to heat the water to be treated in the liquid storage unit; and
a distillation unit configured to separate, using a membrane distillation method, the water-soluble substance and a moisture content from the water to be treated, wherein
the distillation unit includes
a liquid-phase portion into which the water to be treated flows from the liquid storage unit,
a separation portion that is a non-woven fabric using a recycled material as a raw material and on which a carbonization treatment is performed, and
a gas-phase portion into which water vapor diffuses, the water vapor being generated as a result of the water to be treated passing through the separation portion.

2. The liquid treatment device according to claim 1, wherein
the separation portion is a separation membrane produced by binding, into a sheet-like shape, a defibrated material produced by defibrating the recycled material using an impact force.

3. The liquid treatment device according to claim 1, further comprising a depressurizing unit configured to depressurize air in the gas-phase portion.

4. The liquid treatment device according to claim 1, wherein
the separation portion further includes a housing unit configured to house a separation membrane in a circumferential manner, and
the housing unit includes
an inflow port into which the water to be treated flows from the liquid-phase portion, and
an outflow port provided at a surface facing the inflow port and configured to return a liquid containing the water-soluble substance to the liquid-phase portion.

5. The liquid treatment device according to claim 1, wherein
the water-soluble substance is ink.

6. The liquid treatment device according to claim 1, wherein
the recycled material is a material containing hydrophobic synthetic fibers, or a material containing hydrophobic regenerated fibers using a natural material as a raw material.

7. A separation portion configured to be used for membrane distillation that separates a water-soluble substance and a moisture content from water to be treated, the separation portion being a non-woven fabric using a recycled material as a raw material and having hydrophobicity imparted by a carbonization treatment.
